(19) United States
(12) Patent Application Publication
(10) Pub. No.: US 2007/0188122 A1
(43) Pub. Date: Aug. 16, 2007

(54) Rain sensing automatic power windows

(75) Inventor: David J. Andrejciw, Fenton, MI (US)

Correspondence Address: HARNESS, DICKEY & PIERCE, P.L.C., P.O. BOX 828, BLOOMFIELD HILLS, MI, 48303, US

(73) Assignee: DENSO International America, Inc.

(21) Appl. No.: 11/355,388

(22) Filed: Feb. 16, 2006

(51) Int. Cl. H02P 1/04

(52) U.S. Cl. 318/483

(57) ABSTRACT

A control system and method for closing a window on an unattended vehicle includes a window actuator coupled to the window and adapted to move the window. An occupant detection system generates an occupant signal. A rain sensor generates a rain signal. A window obstruction sensor generates an obstruction signal based on an object obstructing a path of the window. A controller communicates with the occupant detection system, the rain sensor and the window obstruction sensor and generates and communicates a window signal to the window actuator based on the occupant signal, the rain signal and the obstruction signal.

### FIELD OF THE INVENTION

The present invention relates to control systems in vehicles and more particularly to a control system for moving a vehicle window from a down position to an up position while the vehicle is unattended.

### BACKGROUND OF THE INVENTION

In automotive vehicles, power windows are common, or windows that may be moved between an open and closed position by moving a switch causing an electric motor to translate the window. As a result, a vehicle occupant may operate a window simply by manipulating such a switch while inside the vehicle. In some instances however, the vehicle may be left unattended with one or more windows in an open position while parked.

Unfortunately, sometimes the weather may change for the worse and it may begin to precipitate. As a result, the precipitation such as rain, sleet or snow may enter the vehicle through the open windows. In some cases, the precipitation may cause damage to the vehicle interior and/or the contents within the vehicle.

A need exits then for a system that closes any open windows of a vehicle when precipitation is detected while the vehicle is unattended.

### SUMMARY OF THE INVENTION

A control system and method for closing a window of an unattended vehicle includes a window actuator coupled to the window and adapted to move the window. An occupant detection system generates an occupant signal. A rain sensor generates a rain signal. A window obstruction sensor generates an obstruction signal based on an object obstructing a path of the window. A controller communicates with the occupant detection system, the rain sensor and the window obstruction sensor and generates and communicates a window signal to the window actuator based on the occupant signal, the rain signal and the obstruction signal.

According to other features, the control system includes a door status sensor that generates a door signal based on the position of a door. The controller generates the window signal based on the door signal. According to one example, the window obstruction sensor may comprise an ultrasonic sensor. Additionally, the window obstruction sensor may utilize an infra-red transmitter and receiver.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram of a control system adapted to close a window of a vehicle according to the present teachings;

FIG. 2 is a side view of an exemplary obstruction system according to the present teachings; and

FIG. 3 is a flow chart illustrating exemplary steps for closing a window of a vehicle according to the present teachings.

### DETAILED DESCRIPTION OF THE PREFERRED EMBODIMENTS

The following description of the preferred embodiment(s) is merely exemplary in nature and is in no way intended to limit the invention, its application, or uses.

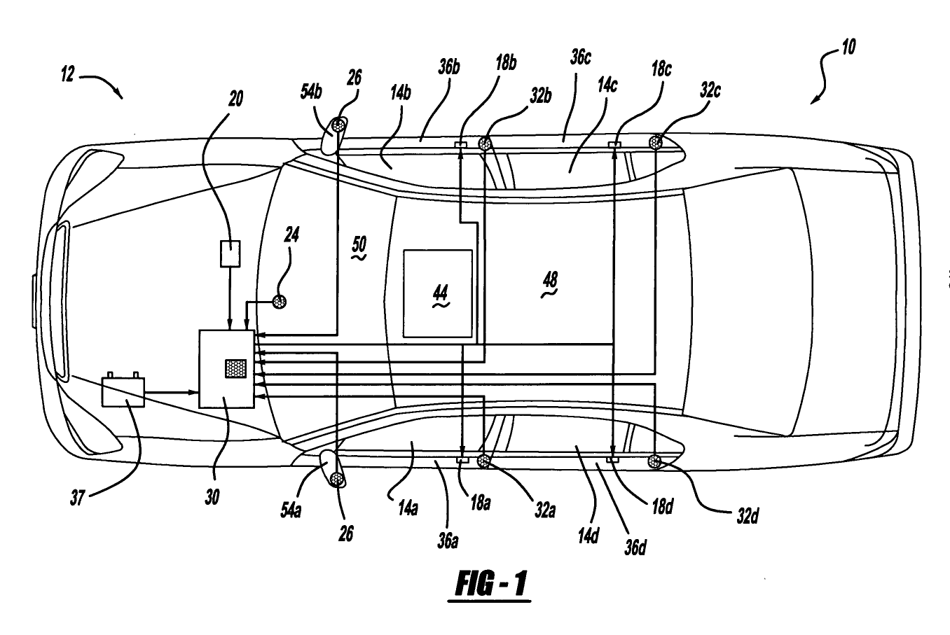

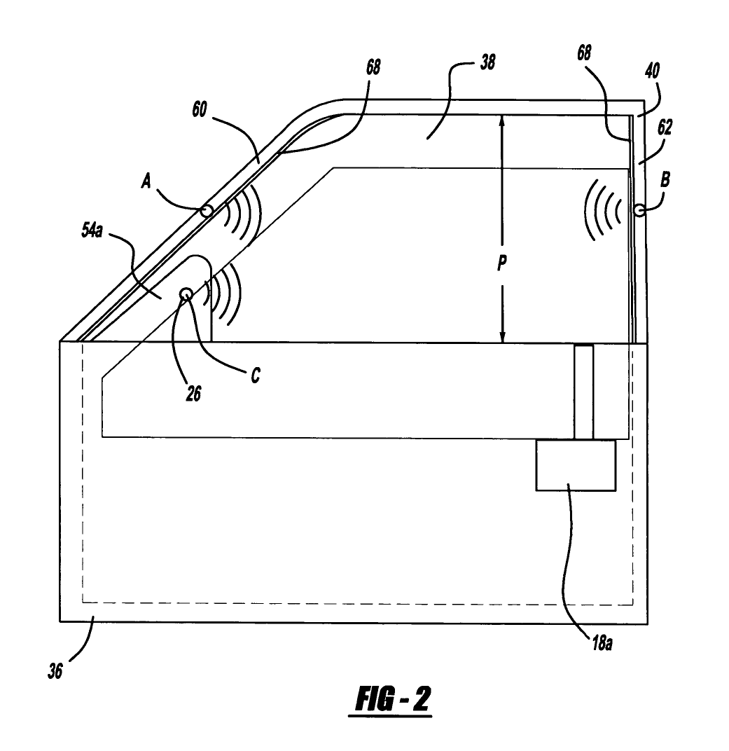

With initial reference to FIG. 1, a block diagram of an exemplary vehicle 10 having a control system 12 for closing a window 14a-14d when the vehicle 10 is unattended is depicted. Generally, the control system 12 may comprise a window actuator 18a-18d, coupled to each respective window 14a-14d, an occupant detection system 20, a rain sensor 24, a window obstruction system 26 and a controller 30. In one example, the controller 30 may be a body control module (BCM). Alternatively, the controller 30 may be a standalone controller or integrated within another vehicle control system. The controller 30 communicates with various components of the control system 12, including but not limited to the occupant detection system 20, the rain sensor 24, the window obstruction sensor 26, door status sensors 32a-32d and the window actuators 18a-18d. The door status sensors 32a-32d may be provided for each respective door 36a-36d. The door status sensors 32a-32d each generate a door signal to the controller 30 based on the position of the respective door 36a-36d. The window actuators 18a-18d may comprise any actuator such as a motor actuator adapted to provide actuation of the respective windows 14a-14d along a window path P (FIG. 2). A battery 37 may provide power to the controller 30.

With continued reference to FIG. 1 and further reference to FIG. 2, the window 14a may generally move within an opening 38 defined by a window frame 40 of the vehicle door 36a. While the following description will be directed to the window 14a (driver side front), of the door 36a, one will appreciate that control of the remaining windows 14b-14d is substantially equivalent. Likewise, while the window path P is shown as generally rectilinear and vertical, the window path may be configured differently, such as in a curvilinear fashion. For example, the window path may alternatively define a path traveled by a pivoting window such as for a window on a mini-van or sport utility vehicle. In addition, the same principles may also be adapted for use on a moveable window pane 44 (FIG. 1) mounted on or within a roof 48 of the vehicle 10, such as a sun roof, moon roof, panoramic roof or others. The window actuator 18a receives a window signal from the controller 12.

The occupant detection system 20 may be any conventional system or module operable to detect whether the vehicle 10 is occupied. In one example, seat sensors may be provided in the vehicle seats (not shown). The seat sensors may measure a weight and communicate a signal indicating the presence of an occupant. In another example, a seat sensor may detect an occupant using infra-red technology, by sensing heat of such an occupant. Other detection systems may be used. The occupant detection system 20 communicates an occupant signal to the controller 30.

The rain sensor 24 may entail any conventional rain sensor operable to detect the presence of moisture on the vehicle 10. In one example, a conventional rain sensor, such as one housed behind a vehicle windshield 50, may be used. The rain sensor 24 may be a rain sensor communicating with windshield wipers (not shown) such as through the BCM 30 and adapted to communicate a rain signal to the BCM 30 indicating precipitation on the windshield 50. In response, the BCM 30 may communicate with the windshield wipers to actuate and remove the precipitation. Other rain sensors may be used.

For illustrative purposes, the window obstruction system 26 is shown simply as part of side rear view mirrors 54a and 54b in FIG. 1. However, the window obstruction system 26 is represented more completely by sensors A, B and C shown in FIG. 2. As will become apparent from the following discussion, a plurality of distinct configurations may be realized. In this regard, each sensor A, B and C may represent a transmitter, a receiver and/or a transceiver. Furthermore, while shown at specific locations on the side rear view mirror 54a, along an A-pillar 60 and a B-pillar 62, the sensors A, B and C may be located at different locations on the window frame 40 or elsewhere proximate the window 14a.

In one example, the window obstruction system 26 may include an ultrasonic sensor. The ultrasonic sensor may be any conventional ultrasonic sensor, such as those utilized in object detection for rear parking aid systems. In one method, the ultrasonic sensor may be adapted to send and/or receive ultrasonic sound waves. The ultrasonic sensor may be located anywhere on or proximate the window frame 40 such as in the locations represented by sensors A-C (FIG. 2).

During operation, a transmitted ultrasonic sound wave may reflect or bounce off of an object and be received by the ultrasonic sensor creating a footprint or feedback, as a signature. For a given window 14a and window frame 40 assembly, a predetermined set of acceptable (non-obstruction) signatures may be stored corresponding to a window down position, a window up position, and a plurality of intermediate positions. In the event of an obstruction occupying the window path P, a unique pattern or signature will be realized. The unique signature may generate an obstruction signal communicated from the window obstruction system 26 to the BCM 30.

In another example, the window obstruction system 26 may include an infrared transmitter and receiver. As illustrated in FIG. 2, sensors A, B and C may each define an infrared transmitter, an infrared receiver (photodiode) or an infrared transceiver. Again, while the sensor A is shown on the A-pillar 60 of the vehicle 10, the sensor B shown on the B-pillar 62 and the sensor C shown on the mirror 54a, some or all of the sensors A-C may be located elsewhere on or proximate the window frame 40. In one example, a strip of reflective coating 68 may be disposed around the window frame 40 such as on the A-pillar 60 and the B-pillar 62. Sensor A may comprise an infrared transmitter adapted to send a modulated infrared light wave toward the reflective coating on the B-pillar 62. A quantity of the reflected modulated light wave received by the photodiode may be calculated. For example, the photodiode may be used to produce a voltage based on the amount of modulated infrared light incident on the photodiode. The calculated voltage may be compared to a baseline voltage of an un-obstructed window opening 38. If the compared voltages are different, an obstruction signal may be communicated to the controller 30. Explained further, since the distance the light wave must travel from transmitter to receiver is different when an obstruction is located in the window path P, a light wave encountering an obstruction will have an amplitude that is out of phase.

In another configuration using infrared technology, pairs of infrared transceivers may be arranged on the A-pillar 60 and the B-pillar 62. An electronic eye beam may be formed between the respective transceivers (such as sensors A and B) when the infrared light wave is unobstructed. If the eye-beam is broken, an obstruction signal may be communicated to the controller 30.

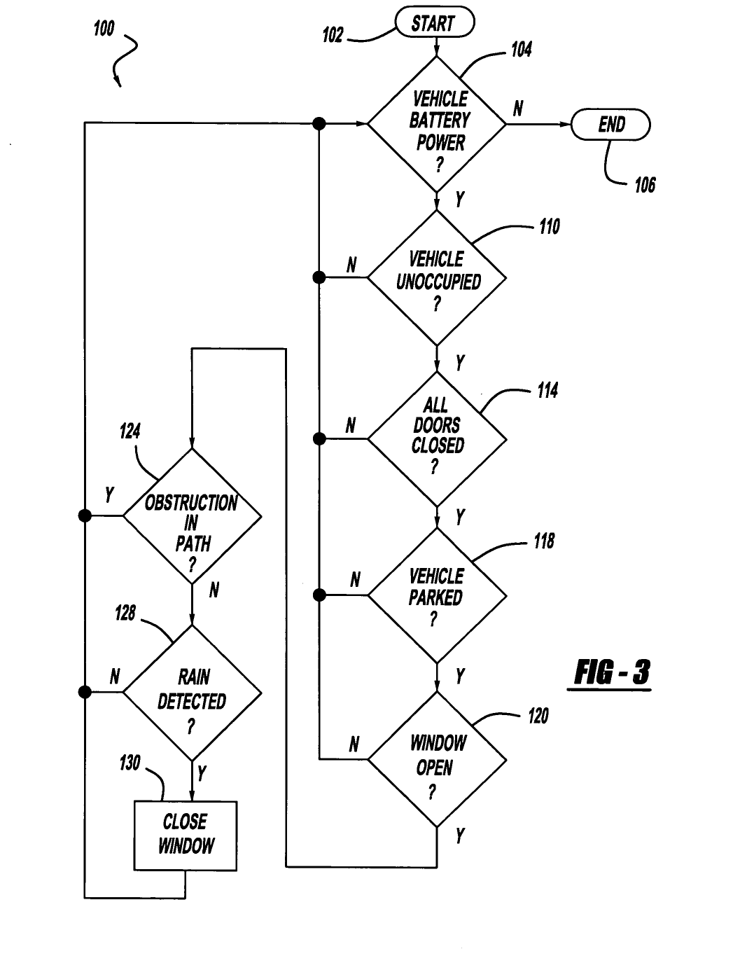

Referring now to FIG. 3, steps for closing a window of an unattended vehicle according to the present teachings are shown generally at 100. Control begins with step 102. In step 104, the controller determines whether the vehicle 10 has battery power. If not, control ends in step 106. If the vehicle 10 has battery power, control determines whether the vehicle 10 is unoccupied in step 110. If not, control loops to step 104. If the vehicle is unoccupied, control determines whether all the vehicle doors are closed in step 114. If not, control loops to step 104. If all the vehicle doors are closed, control determines if the vehicle is in park in step 118. If not, control loops to step 104. If the vehicle is in park, control determines if any of the windows are open in step 120. If none of the windows are open, control loops to step 104. If any of the windows are open, control determines if an obstruction is detected in the window path P in step 124. If an obstruction is detected, control loops to step 104. If an obstruction is not detected in the window path P, control determines if it is rain is detected in step 128. If not, control loops to step 104. If rain has been detected, control communicates a signal to the respective window actuator to close the identified open window in step 130. Control then loops to step 104.

It is appreciated that the exemplary steps illustrated in FIG. 3 may be executed differently. Furthermore, one or more steps may be optional. In one example, step 104 may identify another decision control may execute to determine if control should proceed or end.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A control system for closing a window of an unattended vehicle, comprising:
a window actuator coupled to the window and adapted to move the window;
an occupant detection system that generates an occupant signal;
a rain sensor that generates a rain signal;
a window obstruction sensor that generates an obstruction signal based on an object obstructing a path of the window; and
a controller that communicates with the occupant detection system, the rain sensor and the window obstruction sensor and that generates and communicates a window signal to the window actuator based on the occupant signal, the rain signal and the obstruction signal.

2. The control system of claim 1, further comprising a door status sensor that generates a door signal based on the position of a door.

3. The control system of claim 2 wherein the controller further generates the window signal based on the door signal.

4. The control system of claim 1 wherein the window obstruction sensor comprises an ultrasonic sensor.

5. The control system of claim 1 wherein the window obstruction sensor comprises an infrared transmitter and receiver.

6. The control system of claim 5 wherein the infrared transmitter and receiver are disposed on a window frame of the vehicle.

7. The control system of claim 6, further comprising reflective material disposed on the window frame.

8. The control system of claim 7 wherein the infrared transmitter is operable to transmit an infrared signal toward the reflective material and wherein the infrared receiver is operable to receive the infrared signal from the reflective material.

9. The control system of claim 6 wherein the infrared transmitter and receiver comprise a pair of infrared transmitters and receivers arranged to send and receive signals therebetween.

10. A control system for closing a window of an unattended vehicle, comprising:
a window actuator coupled to the window and adapted to move the window;
an occupant detection system that generates an occupant signal;
a rain sensor that generates a rain signal; and
a controller that communicates with the occupant detection system and the rain sensor and that generates and communicates a window signal to the window actuator based on the occupant signal and the rain signal.

11. A method for closing a window of an unattended vehicle comprising:
determining if the vehicle is unoccupied and generating a resultant occupant signal;
determining if rain is contacting the vehicle and generating a resultant rain signal;
determining if a path of window travel is obstructed and generating a resultant obstruction signal; and
closing the window based on the occupant, rain and obstruction signals.

12. The method of claim 11, further comprising determining if a door is in a closed position and generating a resultant door signal.

13. The method of claim 12 wherein closing the window is further based on the door signal.

14. The method of claim 11 wherein determining if the path of window travel is obstructed includes transmitting an ultrasonic signal proximate the door.

15. The method of claim 11 wherein determining if the path of window travel is obstructed includes transmitting and receiving an infrared signal.

16. The method of claim 15 wherein transmitting the infrared signal includes transmitting the infrared signal from a door frame of the vehicle.

17. The method of claim 15 wherein transmitting the infrared signal includes transmitting the infrared signal from a mirror of the vehicle.

18. The method of claim 15 wherein receiving the infrared signal includes receiving the infrared signal from reflective material disposed proximate a window frame housing the window.

19. The method of claim 15 wherein transmitting and receiving the infrared signal includes transmitting and receiving a pair of infrared signals between a respective pair of infrared transceivers.
